(19) United States
(12) Patent Application Publication
(10) Pub. No.: US 2014/0067585 A1
(43) Pub. Date: Mar. 6, 2014

(54) SYSTEMS AND METHODS FOR DETERMINING LEAN PRICE OPTIMIZATION

(71) Applicants: Amarnath Purohit, Rochester, NY (US); Sudhendu Rai, Fairport, NY (US)

(72) Inventors: Amarnath Purohit, Rochester, NY (US); Sudhendu Rai, Fairport, NY (US)

(73) Assignee: XEROX CORPORATION, Norwalk, CT (US)

(21) Appl. No.: 13/597,484

(22) Filed: Aug. 29, 2012

(51) Int. Cl. G06Q 30/08

(52) U.S. Cl. 705/26.4

(57) ABSTRACT

Methods and systems for improving a cost determination for a job for a supplier are disclosed. A computing device may receive one or more job parameters for the job and one or more shop characteristics for a shop operated by the supplier. The computing device may determine a cost to perform the job in the shop based on the one or more job parameters and the one or more shop characteristics. The determined cost may be transmitted to the supplier.

### BACKGROUND

Large and small companies are often required to purchase a variety of commodity items required to operate their businesses. For example, paper-based products, such as envelopes, paper, marketing pamphlets and/or annual reports may be purchased by a large company in order to satisfy their internal needs and customer or stockholder expectations. However, procuring such products can distract the company from its primary focus. As such, many companies out-source procurement of such products to a procurement provider.

A procurement provider may work with a plurality of third party suppliers in order to identify the appropriate supplier for a particular product and company. For example, when procuring a print job for a particular company, the procurement provider may engage in a reverse auction bidding process with a plurality of suppliers to identify an acceptable price for the company and selected supplier. However, bids in reverse auctions are often made with incomplete information by suppliers who are often unaware of their competitors' capabilities and their own inefficiencies when making their bids.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for improving a cost determination for a job for a supplier may include a computing device and a non-transitory processor-readable storage medium in operable communication with the computing device. The process-readable storage medium contains one or more programming instructions that, when executed, cause the computing device to receive one or more job parameters for the job, receive one or more shop characteristics for a shop operated by the supplier, determine a cost to perform the job in the shop based on the one or more job parameters and the one or more shop characteristics, and transmit the cost to the supplier.

In an embodiment, a method of improving a cost determination for a job for a supplier may include receiving, by a computing device, one or more job parameters for the job, receiving, by the computing device, one or more shop characteristics for a shop operated by the supplier, determining, by the computing device, a cost to perform the job in the shop based on the one or more job parameters and the one or more shop characteristics, and transmitting, by the computing device, the determined cost to the supplier.

In an embodiment, a method of improving a cost determination for a job for a supplier may include receiving, by a computing device, one or more job parameters for the job, receiving, by the computing device, one or more shop characteristics for a shop operated by the supplier, determining, by the computing device, a cost to perform the job in the shop based on the one or more job parameters and the one or more shop characteristics, and causing, by the computing device, a display device to display the determined cost to the supplier.

### BRIEF DESCRIPTION OF THE DRAWINGS

FIG. 1 depicts an exemplary method for improving a cost determination for a job for a supplier according to an embodiment.

FIG. 2 depicts an exemplary job data feed for a scenario analysis request according to an embodiment.

FIG. 3 depicts an alternate exemplary method for improving a cost determination for a job for a supplier according to an embodiment.

FIG. 4 depicts a block diagram of exemplary internal hardware that may be used to contain or implement program instructions according to an embodiment.

### DETAILED DESCRIPTION

The following terms shall have, for the purposes of this application, the respective meanings set forth below.

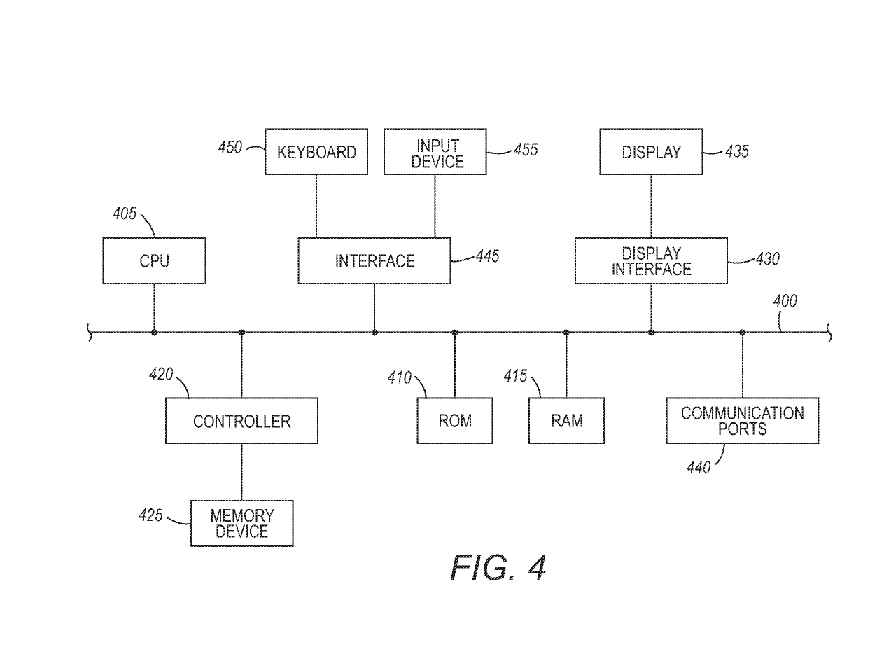

A “computing device” refers to a computer, a processor and/or any other component, device or system that performs one or more operations according to one or more programming instructions. An exemplary computing device is described in reference to FIG. 4.

A “job” refers to a logical unit of work that is to be completed for a customer. In a print production environment, a job may include one or more print jobs from one or more clients.

A “print device” refers to a device capable of performing one or more print-related functions. For example, a print device may include a printer, a scanner, a copy machine, a multifunction device, a collator, a binder, a cutter or other similar equipment. A “multifunction device” is a device that is capable of performing two or more distinct print-related functions. For example, a multifunction device may have print and scan capabilities.

A “print job” refers to a job processed in a print production environment. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “processing rate” refers to a speed with which a machine performs an operation. An exemplary processing rate for a print device may be measured in pages per minute, although other units of measurement may also be used within the scope of this disclosure.

A “setup time” refers to an amount of time required to prepare a machine so that the machine can perform an operation. For example, a print device may require one or more pre-processing steps to be performed prior to performing a print job that require a setup time of 4 minutes.

As used herein, the terms “sum,” “product” and similar mathematical terms are construed broadly to include any method or algorithm in which a single datum is derived or calculated from a plurality of input data.

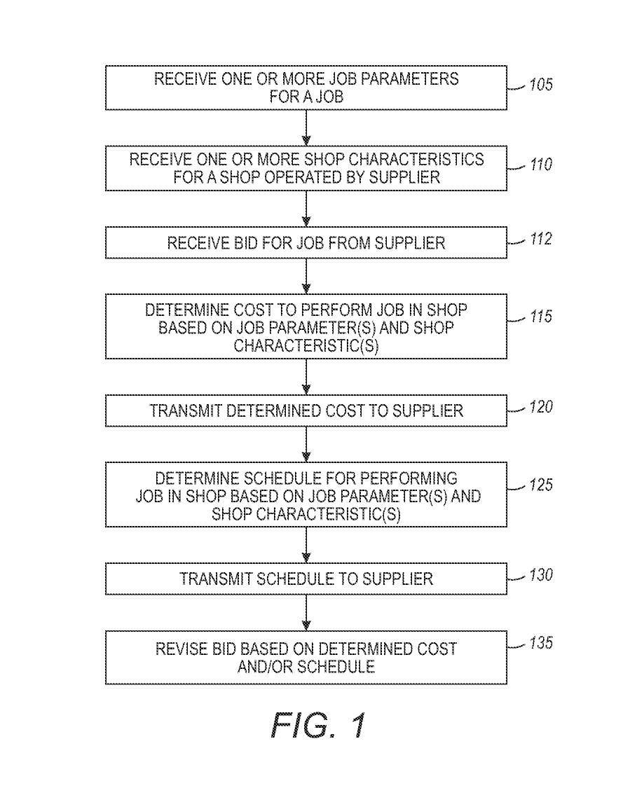

FIG. 1 depicts an exemplary method for improving a cost determination for a job for a supplier according to an embodiment. As shown in FIG. 1, a computing device may receive 105 one or more job parameters for a job. In an embodiment, the job may be a print job. In such an embodiment, the job parameters may be received 105 from a customer or organization desiring that a print shop perform the operations for the print job. The job parameters may include, without limitation, a number of pages to print, whether the job requires color printing, an output format (page size, stapling, binding, etc.) and the like. Alternate types of jobs, alternate job parameters associated with such alternate job types and/or additional or alternate job parameters for a print job may be used within the scope of this disclosure.

The computing device may receive 110 one or more shop characteristics for a shop operated by the supplier. In an embodiment, the one or more shop characteristics may be received 110 during a reverse auction bidding process. The one or more shop characteristics may be received 110 from a supplier, such as a print shop. In an embodiment, the one or more shop characteristics may be received 110 in a manner which is transparent to the print shop. In an alternate embodiment, the one or more shop characteristics may be received 110 from an operator of the shop. In an embodiment, the one or more shop characteristics may identify a plurality of workers for the shop and one or more skills for each worker. In an embodiment, the one or more shop characteristics may include a plurality of devices used in the shop, one or more capabilities for each device and a speed for each device. In an embodiment, the one or more shop characteristics may include one or more pending jobs for the shop and scheduling information for each job pending in the shop. Additional and/or alternate shop characteristics may also be used within the scope of this disclosure.

In an embodiment, the shop characteristics may be received 110 in a common format, such as in an XML file. Alternate and/or additional file formats may be used within the scope of this disclosure. In an embodiment, the received file may provide the following information:

TABLE 1
Exemplary Shop Characteristics File Format

Shop: Name, Type, Status, Comment, Creator, Version

Shop Configuration: CellAssignmentPolicy, SequencingPolicy,
BatchLimit
Service Provider
Schedule:

Weekday Schedule

Station: Name, Type, Status, Comment, Barcode, StationID

Schedule

Weekday Schedule

SimpleFunctionSequence: Name, Operator Demand, SetupTime,
SpeedValue, TimeUnit, Quality, MinBactch, Barcode

SimpleFunction

Operator: Name, ResourceID, Barcode

Schedule

Weekday Schedule

OperatorSkill: Example Punch, Color Printing, CoilBind,
BWPrinting
Cell: CellID, Name, Type, Status, Comment

CellConfiguration: ControlPolicy, ControlParameter,
Batching, OperatorLimited, UseOperatorSkills,
UseOperatorSchedules
Stations

Reference

An exemplary XML file may include the following information based on the exemplary shop characteristics from Table 1:

TABLE 2
Exemplary XML Shop Characteristics File

```
<ShopName=“My Shop” Type=“Shop” Status=“0” Comment=“The Shop”
      Creator=“MarketPortSuite” Version=“2.0.2”>
<ShopConfigurationCellAssignmentPolicy=“minmax” SequencingPolicy=“leastSlack”
      BatchLimit=“0”/>
<ServiceProvider></CommercialPrint></ServiceProvider>
<Schedule></WeekdaySchedule></Schedule>
<StationName=“Punch” Type=“Station” Status=“0” Comment=“Punch” Barcode=“990006”
      StationID=“11”>
<Schedule></WeekdaySchedule></Schedule>
<SimpleFunctionSequenceName=“Punch” OperatorDemand=“1.0” SetupTime=“0.0”
      SpeedValue=“10000.0” SpeedUnit=“Pages” TimeUnit=“hour” Quality=“0”
      Minbatch=“50” Barcode=“8800”)
<SimpleFunctionName=“Punch”/></SimplefunctionSequence>
</Station>
<OperatorName=“Bob” ResourceID=“5” Barcode=“100002”>
<Schedule></WeekdaySchedule></Schedule>
<OperatorSkillSkill=“Punch”/>
<CellCellID=“Cell_1” Name=“Department” Type=“” Status=“0” Comment=“”>
<CellConfigurationControlPolicy=“0” ControlParameter=“1” Batching=“false”
      OperatorLimited=“false” UseOperatorSkills=“false” UseOperatorSchedules=“false”/>
</Cell>
</Shop>
```

The computing device may determine 115 a cost to perform the job in the shop based on the one or more job parameters and the one or more shop characteristics. The cost may be determined 115 by identifying one or more devices in the shop that can be used to perform at least one operation for the job. In an embodiment, the determination 115 of the cost may consider whether each of the one or more devices are available based on substantially real time information. In an embodiment, the processing rate and setup time for each of the one or more devices may be used to determine the amount of time required for the device to perform the operation for the job. Discrete-event simulation models may be utilized to determine the amount of equipment, operator time, and material resources used to produce the job. The cost may be determined 115 based at least on part upon an amount of time that each of the one or more devices would be required to be used in order to complete the time and a cost per unit time for each of the devices. Additional costs for performing the job may include labor costs, overhead costs, and the like. Additional and/or alternate methods of determining a cost may also be used within the scope of this disclosure.

In an embodiment, the process of determining 115 the cost may be performed by time-driven activity based costing. Time-driven activity based costing may require estimates of only two parameters: (1) a unit cost of supplying an activity and (2) a time required to perform the activity. Time-driven activity based costing may be performed using the methods disclosed in Kaplan et al., “Time-Driven Activity Based Costing” (November 2003). In an embodiment, determining 115 a cost may result from an amount of time required to perform an activity and a cost for performing work for a unit of time. By multiplying these two values, the cost for performing the particular activity may be determined 115.

In an alternate embodiment, the process of determining 115 the cost may be performed by a standard costing model. When using a standard costing model, the total costs incurred by a production facility may be allocated to different production activities to identify a unit cost for each production component (for example, binding costs are $1 per book, printing costs are 3 cents per page, or the like). The costs may be computed based on summing up the unit costs of all components of an item.

The computing device may transmit 120 the determined cost to the supplier. For example, the computing device may transmit 120 the determined cost to the supplier via a communication network, such as the Internet, an intranet, a telephone network, or the like. The computing device may transmit 120 the determined cost to a remote computer, a mobile device, and/or any other system operated by the supplier. Additional and/or alternate methods of transmitting the cost to the supplier may also be performed within the scope of this disclosure.

In an embodiment, the computing device may further determine 125 a schedule for performing the job in the shop based on the one or more job parameters and the one or more shop characteristics. The schedule may identify one or more devices operated by the supplier and the operations to be performed by the devices. In addition, the schedule may identify one or more device operators and the approximate cost associated with such device operators. In an embodiment, the schedule may account for work already in process at the shop when considering whether a particular device or device operator is available to perform the requested job. Once a schedule has been determined 125, the computing device may transmit 130 the schedule to the supplier. The schedule may be transmitted 130 to the supplier at substantially the same time that the cost is transmitted 120 or at any other time.

In an embodiment, the computing device may receive 112 a bid for the job from the supplier. The bid may be received 112 from the supplier prior to determining a schedule or a cost associated with the supplier to perform the job. In such an embodiment, the computing device may revise 135 the bid based on the determined cost and/or schedule. For example, the computing device may identify a schedule for performing the job that significantly reduces the cost to the supplier. As such, the bid may be revised 135 downward.

In an alternate embodiment, the bid may be received 112 after the schedule and cost have been provided to the supplier. In such an embodiment, the bid may account for the schedule and/or cost identified by the computing device. As such, the supplier may be able to have a more accurate bid for submission resulting in a greater likelihood that the bid will be selected by the job requester. Alternate methods of determining a bid may be performed within the scope of this disclosure.

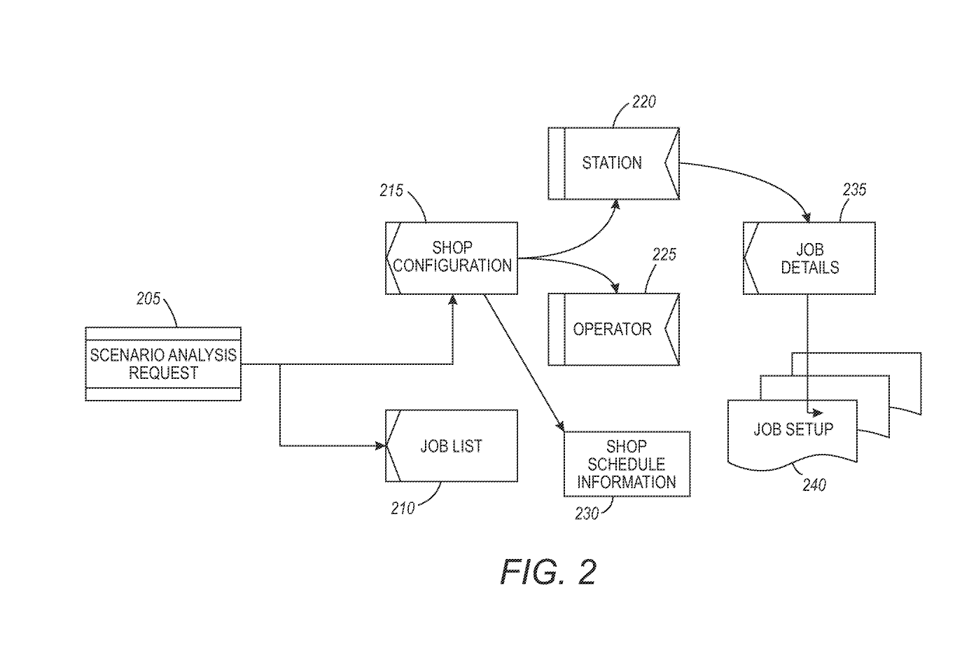

FIG. 2 depicts a job data feed for a scenario analysis request according to an embodiment. As shown in FIG. 2, a request for a scenario analysis 205 may be received. The scenario analysis request 205 may be received, for example, by a computing device. The computing device may identify a job list 210 from the scenario analysis request. The job list 210 may be used to identify the types of operations to be performed, the number of output products (such as pages or impressions for a print job) to produce, particular characteristics for the output products and the like.

The scenario analysis request 205 may also include a shop configuration 215 for a supplier. The shop configuration 215 may include parameters identifying one or more stations 220, one or more operators 225 and/or scheduling information 230. Parameters for a station 220 may include the one or more operations that the station performs, a setup time associated with the station, a processing rate associated with the station for each operation, and the like. Parameters for an operator 225 may include a skill set for the operator with respect to a plurality of operations performed by the supplier, a proficiency with respect to each skill for the operator, a work schedule for the operator, a cost per unit time for the operator, availability for overtime, and/or the like. Scheduling information 230 may include the hours of operation for the shop, a list of jobs that are currently in process at the shop and parameters for each of such jobs, and/or the like.

In an embodiment, the station 220 parameters may include real time or near real time information for the station. For example, the parameters for the station 220 may identify a list of jobs that are currently in process at the station, and a plurality of details 235 for each job. From this information, the amount of availability for such station during the time before the job under consideration is required to be completed may be determined. In addition, the job details may include job setup 240 information, which, among other things, identifies the type of products that may be required to perform a job. For example, the job setup 240 information may identify that a particular print job requires a particular physical medium on which to print the print job, and the amount of setup time required to stop the previous job and prepare the identified job for performance at the station. Additional and/or alternate information may be used within the scope of this disclosure.

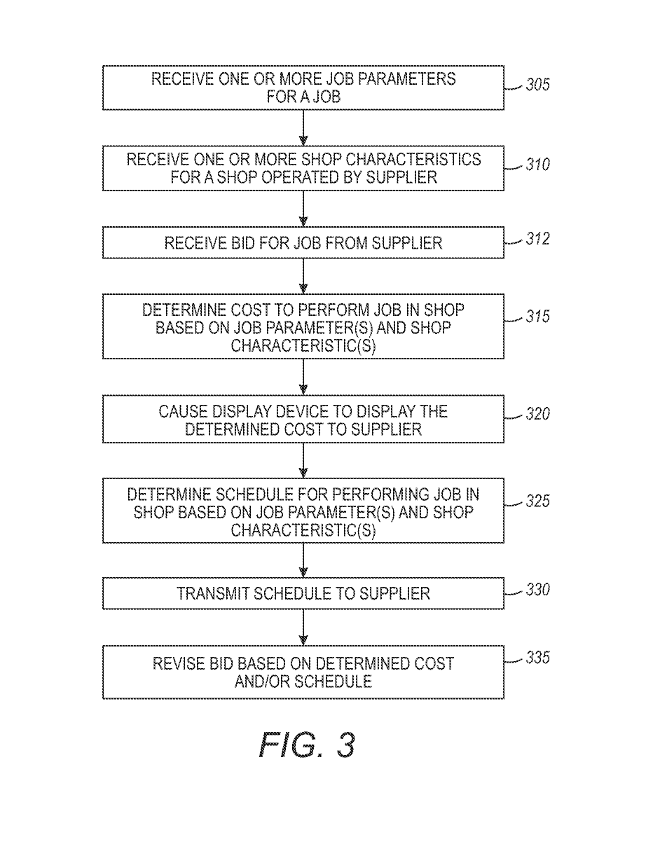

FIG. 3 depicts an alternate exemplary method for improving a cost determination for a job for a supplier according to an embodiment. As shown in FIG. 3, a computing device may receive 305 one or more job parameters for a job. In an embodiment, the job may be a print job. In such an embodiment, the job parameters may be received 305 from a customer or organization desiring that a print shop perform the operations for the print job. The job parameters may include, without limitation, a number of pages to print, whether the job requires color printing, an output format (page size, stapling, binding, etc.) and the like. Alternate types of jobs, alternate job parameters associated with such alternate job types and/or additional or alternate job parameters for a print job may be used within the scope of this disclosure.

The computing device may receive 310 one or more shop characteristics for a shop operated by the supplier. In an embodiment, the one or more shop characteristics may be received 310 during a reverse auction bidding process. The one or more shop characteristics may be received 310 from a supplier, such as a print shop. In an embodiment, the one or more shop characteristics may be received 310 in a manner which is transparent to the print shop. In an alternate embodiment, the one or more shop characteristics may be received 310 from an operator of the shop. In an embodiment, the one or more shop characteristics may identify a plurality of workers for the shop and one or more skills for each worker. In an embodiment, the one or more shop characteristics may include a plurality of devices used in the shop, one or more capabilities for each device and a speed for each device. In an embodiment, the one or more shop characteristics may include one or more pending jobs for the shop and scheduling information for each job pending in the shop. Additional and/or alternate shop characteristics may also be used within the scope of this disclosure.

In an embodiment, the shop characteristics may be received 310 in a common format, such as in an XML file. Alternate and/or additional file formats may be used within the scope of this disclosure.

The computing device may determine 315 a cost to perform the job in the shop based on the one or more job parameters and the one or more shop characteristics. The cost may be determined 315 by identifying one or more devices in the shop that can be used to perform at least one operation for the job. In an embodiment, the determination 315 of the cost may consider whether each of the one or more devices are available based on substantially real time information. In an embodiment, the processing rate and setup time for each of the one or more devices may be used to determine the amount of time required for the device to perform the operation for the job. Discrete-event simulation models may be utilized to determine the amount of equipment, operator time, and material resources used to produce the job. The cost may then be determined 315 based at least on part upon an amount of time that each of the one or more devices would be required to be used in order to complete the time and a cost per unit time for each of the devices. Additional costs for performing the job may include labor costs, overhead costs, and the like. Additional and/or alternate methods of determining a cost may also be used within the scope of this disclosure.

In an embodiment, the process of determining 315 the cost may be performed by time-driven activity based costing. Time-driven activity based costing may require estimates of only two parameters: (1) the unit cost of supplying an activity and (2) the time required to perform a transaction or an activity. Time-driven activity based costing may be performed using the methods disclosed in Kaplan et al., “Time-Drive Activity Based Costing” (November 2003).

In an alternate embodiment, the process of determining 315 the cost may be performed by the standard costing model. When using the standard costing model, the total costs incurred by a production facility may be allocated to different production activities to identify a unit cost for each production component (for example, binding costs are $1 per book, printing costs are 3 cents per page, or the like). The costs may be computed based on summing up the unit costs of all components of an item.

The computing device may cause 320 a display device to display the determined cost to a supplier. In an embodiment, the display device may be remote from the computing device. Alternately, the display device may be in direct communication with the computing device. In an embodiment, the cost may be displayed via a World Wide Web interface. The Web interface may be used as part of a reverse auction bidding process conducted with a plurality of suppliers simultaneously. Additional and/or alternate methods of displaying the determined cost to the supplier may also be performed within the scope of this disclosure.

In an embodiment, the computing device may further determine 325 a schedule for performing the job in the shop based on the one or more job parameters and the one or more shop characteristics. The schedule may identify one or more devices operated by the supplier and the operations to be performed by the devices. In addition, the schedule may identify one or more device operators and the approximate cost associated with such device operators. In an embodiment, the schedule may account for work already in process at the shop when considering whether a particular device or device operator is available to perform the requested job. Once a schedule has been determined 325, the computing device may cause 330 the schedule to be displayed to the supplier on the display device. The schedule may be caused 330 to be displayed to the supplier at substantially the same time that the cost is caused to be displayed 320 or at any other time.

In an embodiment, the computing device may receive 312 a bid for the job from the supplier. The bid may be received 312 from the supplier prior to determining a schedule or a cost associated with the supplier to perform the job. In such an embodiment, the computing device may revise 335 the bid based on the determined cost and/or schedule. For example, the computing device may identify a schedule for performing the job that significantly reduces the cost to the supplier. As such, the bid may be revised 335 downward.

In an alternate embodiment, the bid may be received 312 after the schedule and cost have been provided to the supplier. In such an embodiment, the bid may account for the schedule and/or cost identified by the computing device. As such, the supplier may be able to have a more accurate bid for submission resulting in a greater likelihood that the bid will be selected by the job requester. Alternate methods of determining a bid may be performed within the scope of this disclosure.

FIG. 4 depicts a block diagram of exemplary internal hardware that may be used to contain or implement program instructions, such as the process steps discussed above in reference to FIG. 2, according to embodiments. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 410 and random access memory (RAM) 415 constitute exemplary memory devices (i.e., processor-readable non-transitory storage media).

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 430 may permit information from the bus 400 to be displayed on the display 435 in audio, visual, graphic or alphanumeric format. Communication with external devices, such as a print device, may occur using various communication ports 440. An exemplary communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A system for improving a cost determination for a job for a supplier, the system comprising:
a computing device; and
a non-transitory processor-readable storage medium in operable communication with the computing device,
wherein the process-readable storage medium contains one or more programming instructions that, when executed, cause the computing device to:
receive one or more job parameters for the job,
receive one or more shop characteristics for a shop operated by the supplier,
determine a cost to perform the job in the shop based on the one or more job parameters and the one or more shop characteristics, and
transmit the cost to the supplier.

2. The system of claim 1, wherein the one or more instructions that, when executed, cause the processor to receive one or more shop characteristics for a shop operated by the supplier comprise one or more instructions that, when executed, cause the process to receive one or more shop characteristics for a shop operated by the supplier during a reverse auction bidding process.

3. The system of claim 1, wherein the one or more instructions that, when executed, cause the processor to receive one or more job parameters for the job comprise one or more instructions that, when executed, cause the process to receive an amount of time required to perform the job and a cost for performing work for a unit of time.

4. The system of claim 1, wherein the one or more shop characteristics comprise a plurality of workers for the shop and one or more skills for each worker.

5. The system of claim 1, wherein the one or more shop characteristics comprise a list of a plurality of devices used in the shop, and one or more of one or more capabilities for each device of the plurality of devices and a speed for each device of the plurality of devices.

6. The system of claim 1, wherein the one or more shop characteristics comprises one or more pending jobs for the shop and scheduling information for the shop.

7. The system of claim 1, wherein the processor-readable storage medium further comprises one or more instructions that, when executed, cause the computing device to:
determine a schedule for performing the job in the shop based on the one or more job parameters and the one or more shop characteristics; and
transmit the schedule to the supplier.

8. A method of improving a cost determination for a job for a supplier, the method comprising:
receiving, by a computing device, one or more job parameters for the job;
receiving, by the computing device, one or more shop characteristics for a shop operated by the supplier;
determining, by the computing device, a cost to perform the job in the shop based on the one or more job parameters and the one or more shop characteristics, and
transmitting, by the computing device, the determined cost to the supplier.

9. The method of claim 8, wherein receiving the one or more shop characteristics for the shop operated by the supplier comprises receiving the one or more shop characteristics for the shop operated by the supplier during a reverse auction bidding process.

10. The method of claim 8, wherein receiving one or more job parameters for a job comprises receiving an amount of time required to perform the job and a cost for performing work for a unit of time.

11. The method of claim 8, wherein the one or more shop characteristics comprise a plurality of workers for the shop and one or more skills for each worker.

12. The method of claim 8, wherein the one or more shop characteristics comprise a list of a plurality of devices used in the shop, and one or more of one or more capabilities for each device of the plurality of devices and a speed for each device of the plurality of devices.

13. The method of claim 8, wherein the one or more shop characteristics comprises one or more pending jobs for the shop and scheduling information for the shop.

14. The method of claim 8, further comprising:
determining, by the computing device, a schedule for performing the job in the shop based on the one or more job parameters and the one or more shop characteristics; and
transmitting, by the computing device, the schedule to the supplier.

15. The method of claim 8, further comprising:
receiving, by the computing device, a bid for the job from the supplier; and
revising, by the computing device, the bid based on the determined cost.

16. A method of improving a cost determination for a job for a supplier, the method comprising:
receiving, by a computing device, one or more job parameters for the job;
receiving, by the computing device, one or more shop characteristics for a shop operated by the supplier;
determining, by the computing device, a cost to perform the job in the shop based on the one or more job parameters and the one or more shop characteristics, and
causing, by the computing device, a display device to display the determined cost to the supplier.

17. The method of claim 16, wherein receiving the one or more shop characteristics for the shop operated by the supplier comprises receiving the one or more shop characteristics for the shop operated by the supplier during a reverse auction bidding process.

18. The method of claim 16, wherein the one or more shop characteristics comprise a plurality of workers for the shop and one or more skills for each worker.

19. The method of claim 16, wherein the one or more shop characteristics comprise a list of a plurality of devices used in the shop, and one or more of one or more capabilities for each device of the plurality of devices, and a speed for each device of the plurality of devices.

20. The method of claim 16, wherein the one or more shop characteristics comprises one or more pending jobs for the shop and scheduling information for the shop.

21. The method of claim 16, further comprising:
determining, by the computing device, a schedule for performing the job in the shop based on the one or more job parameters and the one or more shop characteristics; and
causing, by the computing device, a display device to display the schedule to the supplier.

22. The method of claim 16, further comprising:
receiving, by the computing device, a bid for the job from the supplier; and
revising, by the computing device, the bid based on the determined cost.
